(19) United States
(12) Patent Application Publication
(10) Pub. No.: US 2024/0285383 A1
(43) Pub. Date: Aug. 29, 2024

(54) NOZZLE STRUCTURE AND ORAL IRRIGATOR THEREOF

(71) Applicant: SHENZHEN RISUN TECHNOLOGY CO., LTD., Shenzhen (CN)

(72) Inventors: Hongtao ZHOU, Shenzhen (CN); Dongbao LI, Shenzhen (CN)

(73) Assignee: SHENZHEN RISUN TECHNOLOGY CO., LTD., Shenzhen (CN)

(21) Appl. No.: 18/659,936

(22) Filed: May 9, 2024

Related U.S. Application Data
(63) Continuation of application No. PCT/CN2023/125710, filed on Oct. 20, 2023.

(30) Foreign Application Priority Data
Aug. 23, 2022 (CN) 202211017619.4

(51) Int. Cl. A61C 19/06; A61C 17/02

(52) U.S. Cl. CPC A61C 19/066; A61C 17/02

(57) ABSTRACT

Disclosed are a nozzle structure and an oral irrigator thereof. The nozzle structure includes a base and a nozzle connected to the base. The base is provided with a receiving groove, and a whitening agent is provided inside the receiving groove. The base is provided with a water inlet channel communicated with the receiving groove. The nozzle is provided with a water outlet channel configured to facilitate outflow of whitening liquid, and a filter screen for filtering the whitening liquid is installed at one side of the water outlet channel.

### CROSS-REFERENCE TO RELATED APPLICATIONS

The present application is a continuation application of International Application No. PCT/CN2023/125710, filed on Oct. 20, 2023, which claims priority to Chinese Patent Application No. 202211017619.4, filed on Aug. 23, 2022. All of the aforementioned applications are incorporated herein by reference in their entireties.

### TECHNICAL FIELD

The present application relates to the technical field of nozzle whitening, and in particular to a nozzle structure and an oral irrigator thereof.

### BACKGROUND

In the related art, the oral irrigator is widely used in people's daily lives. The oral irrigator is used to care for the oral cavity. Through a certain pressure, the oral irrigator can eject a cleaning water column from the nozzle of the oral irrigator, to clean the user's oral cavity. However, the nozzle has a water discharge function, and its function is relatively single, which lacks a whitening function, and cannot meet the actual needs of users.

Therefore, how to provide a nozzle structure and an oral irrigator thereof so that the nozzle has a whitening function has become an urgent technical problem to be solved.

### SUMMARY

The technical problem to be solved in the present application is how to provide a nozzle structure and an oral irrigator thereof, so that the nozzle has a whitening function.

In view of this, according to a first aspect, embodiments of the present application disclose a nozzle structure including a base and a nozzle connected to the base. The base is provided with a receiving groove, and a whitening agent is provided inside the receiving groove. The base is provided with a water inlet channel communicated with the receiving groove. The nozzle is provided with a water outlet channel configured to facilitate outflow of whitening liquid, and a filter screen for filtering the whitening liquid is installed at one side of the water outlet channel.

In an embodiment, the nozzle is threadedly connected to the base.

In an embodiment, the nozzle is fixedly connected to the base through screws.

In an embodiment, the nozzle is snapped on and fastened to the base.

In an embodiment, the base is provided with a positioning post, and the nozzle is provided with a positioning hole configured to be snapped on and match with the positioning post.

In an embodiment, the nozzle is provided with an installation groove communicated with the water outlet channel, the filter screen is embedded in the installation groove, and the installation groove is provided with a fastening block for abutting against the filter screen.

In an embodiment, the fastening block is provided with a through hole communicated with the installation groove.

In an embodiment, a sealing ring is provided between the base and the nozzle.

In an embodiment, the whitening agent is a solid tablet or paste.

In view of this, according to a second aspect, embodiments of the present application disclose an oral irrigator including an oral irrigator body and the nozzle structure according to the first aspect. The nozzle structure is detachably installed at the oral irrigator body, and the nozzle structure is configured to spray the whitening liquid.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, other drawings can be obtained according to these drawings without creative effort.

FIG. 1 is a schematic three-dimensional structural diagram of a nozzle structure according to a first embodiment of the present application.

FIG. 2 is a schematic side diagram of the nozzle structure according to the first embodiment of the present application.

FIG. 3 is a schematic cross-sectional structural diagram of FIG. 2.

FIG. 4 is a schematic exploded structural diagram of the nozzle structure according to the first embodiment of the present application.

FIG. 5 is a schematic three-dimensional structural diagram of a filter screen in the nozzle structure according to the first embodiment of the present application.

FIG. 6 is a schematic three-dimensional structural diagram of the nozzle structure according to a second embodiment of the present application.

FIG. 7 is a schematic exploded structural diagram of the nozzle structure according to the second embodiment of the present application.

FIG. 8 is a schematic three-dimensional structural diagram of the nozzle structure according to a third embodiment of the present application.

FIG. 9 is a schematic exploded structural diagram of the nozzle structure according to the third embodiment of the present application.

FIG. 10 is a schematic three-dimensional structural diagram of the nozzle structure according to a fourth embodiment of the present application.

FIG. 11 is a schematic exploded structural diagram of the nozzle structure according to the fourth embodiment of the present application.

### DETAILED DESCRIPTION OF THE EMBODIMENTS

In order to make the purpose, technical solutions and advantages of the present application clearer, the present application will be further described in detail below with reference to the drawings and embodiments. It should be understood that the embodiments described here are only used to explain the present application and are not used to limit the present application.

In the present application, unless otherwise clearly specified and limited, the terms “connected”, “fixed”, “connection”, etc. should be interpreted broadly. For example, “fixed” can be a fixed connection, a detachable connection, or a whole; can be a mechanical connection or an electrical connection; may be directly connected, or indirectly connected through an intermediate medium, and may be the internal communication between two elements; can be a wireless connection or a wired connection. For those skilled in the art, the specific meaning of the above-mentioned terms in the present application can be understood according to specific circumstances.

In the description of the present application, it should be noted that the terms “center”, “upper”, “lower”, “left”, “right”, “vertical”, “horizontal”, “inner”, “outer”, etc. that indicate orientation or positional relationship is based on the orientation or positional relationship shown in the drawings, which is only for the convenience of describing the present application and simplifying the description and does not indicate or imply that the device or element referred to must have a specific orientation or be constructed and operated in such a specific orientation. Therefore, it should not be understood as limitations on the present application. Furthermore, the terms “first”, “second”, and “third”, are used for describing purposes only and are not to indicate or imply relative importance.

In addition, the technical features in different embodiments of the present application described below can be combined with each other as long as they do not conflict with each other.

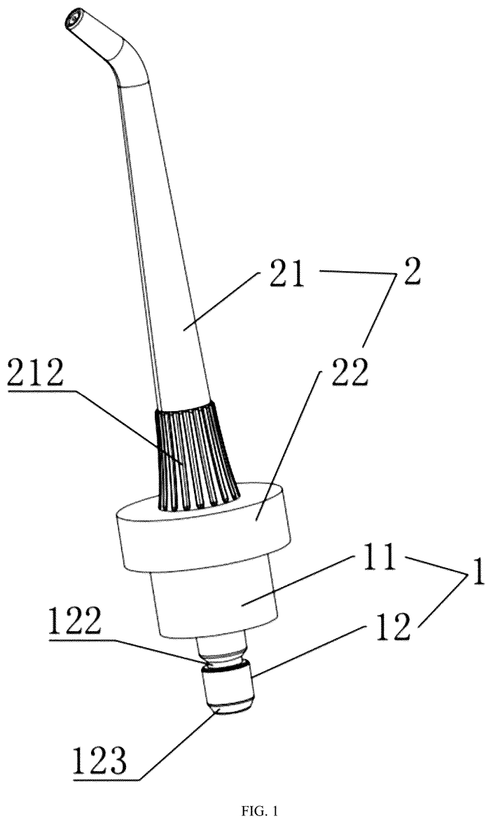

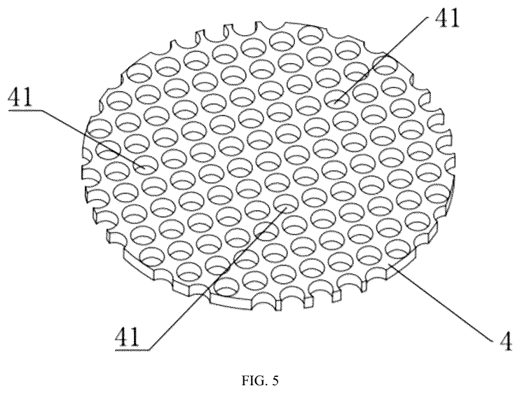

Embodiments of the present application disclose a nozzle structure, as shown in FIG. 1 to FIG. 11, including a base 1 and a nozzle 2 detachably connected to the base 1. The base 1 is provided with a receiving groove 111, and the receiving groove 111 is provided with a whitening agent 3. The base 1 is provided with a water inlet channel 121 that communicates with the receiving groove 111. The nozzle 2 is provided with a water outlet channel 211 which facilitates outflow of a whitening liquid, and a filter screen 4 for filtering the whitening liquid is installed at one side of the water outlet channel 211.

It should be noted that water enters the receiving groove 111 through the water inlet channel 121, and impacts the whitening agent 3 to form the whitening liquid. The filter screen 4 filters the whitening liquid, and then sprays out from the water outlet channel 211 of the nozzle 2 to rinse the user's teeth and realize whitening. Thus, the present application provides a nozzle structure and an oral irrigator thereof, so that the nozzle has a whitening function. The structure is simple, and the product manufacturing cost can be effectively reduced.

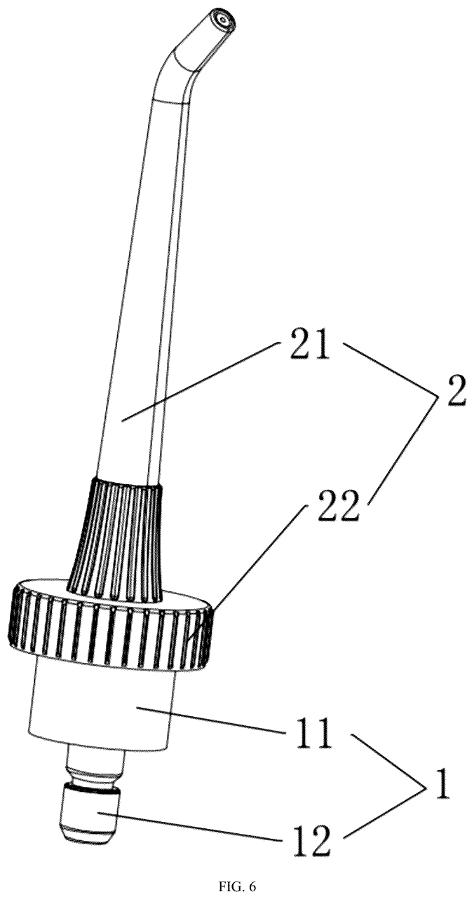

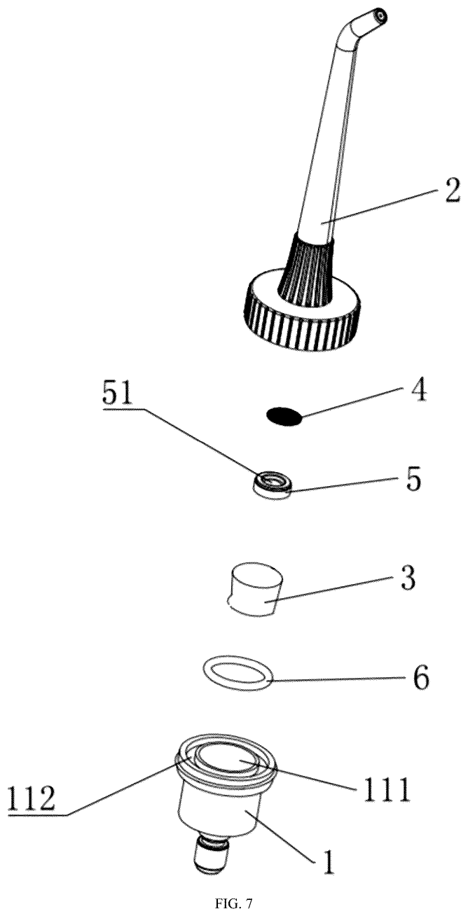

As shown in FIG. 6 and FIG. 7, the nozzle 2 is threadedly connected to the base 1. During the specific implementation process, the nozzle 2 is provided with a protrusion to facilitate rotation.

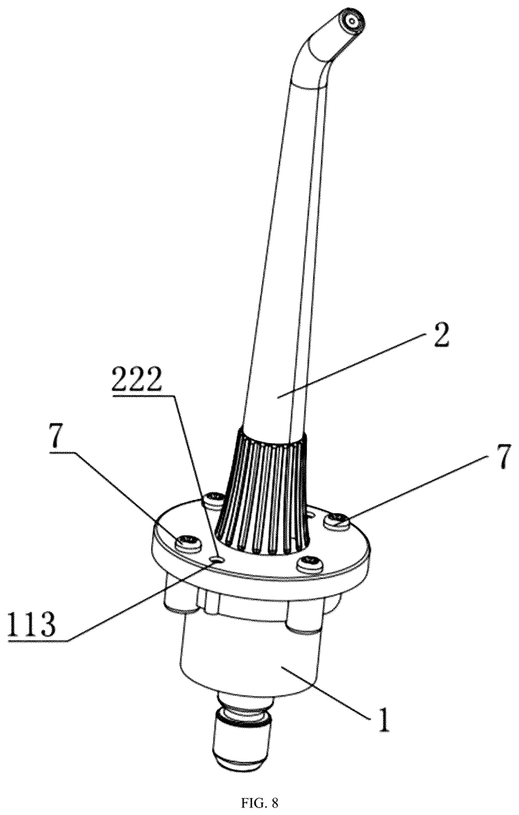

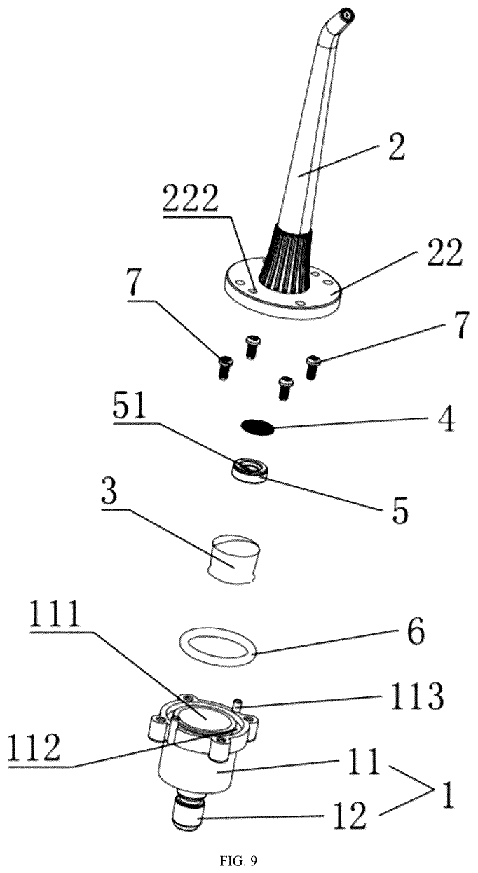

As shown in FIG. 8 and FIG. 9, the nozzle 2 is fixedly connected to the base 1 through screws 7.

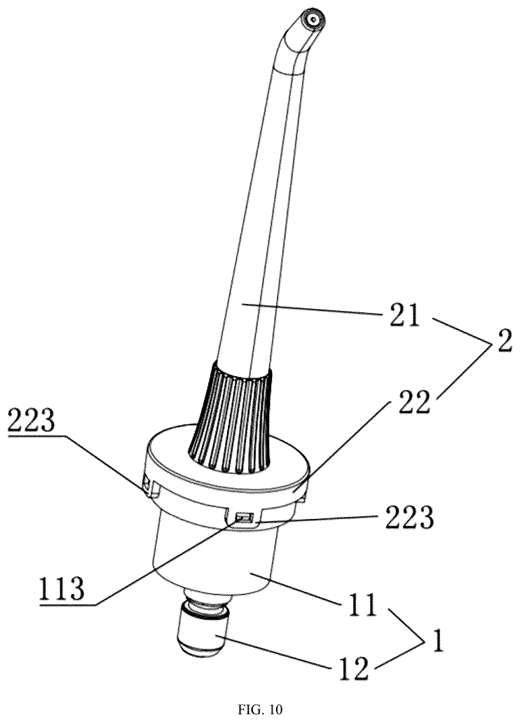

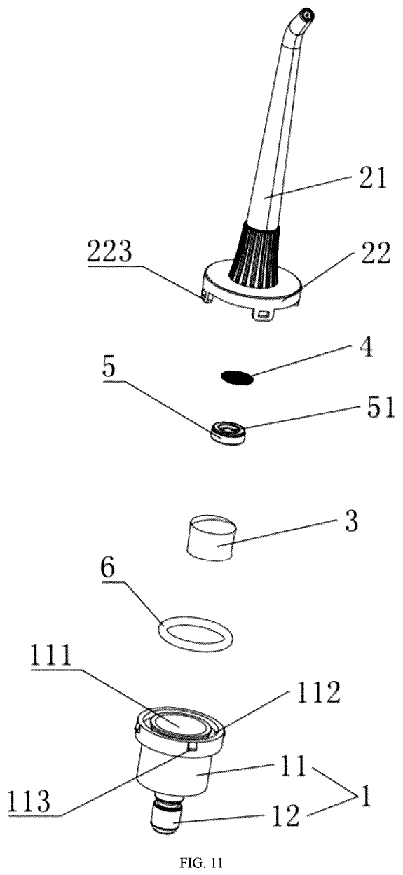

As shown in FIG. 10 and FIG. 11, the nozzle 2 is snapped on and fastened to the base 1. During the specific implementation process, the base 1 is provided with a clamping platform 114, and the nozzle 2 is provided with a hook 223 that engages with the clamping platform 114.

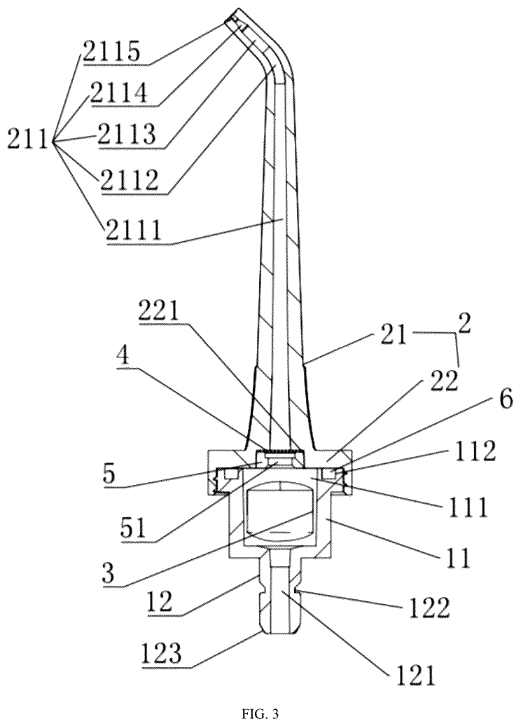

During the specific implementation process, as shown in FIG. 3, the water outlet channel 211 includes a first channel 2111, a second channel 2112, a third channel 2113, a fourth channel 2114 and a fifth channel 2115. The inner diameter of the first channel 2111 decreases along the water outlet direction. The cross-section of the second channel 2112 is shaped in an arc. The inner diameter of the fourth channel 2114 decreases along the water outlet direction. The cross-sections of the first channel 2111, the second channel 2112, the third channel 2113, the fourth channel 2114 and the fifth channel 2115 are shaped in the circle.

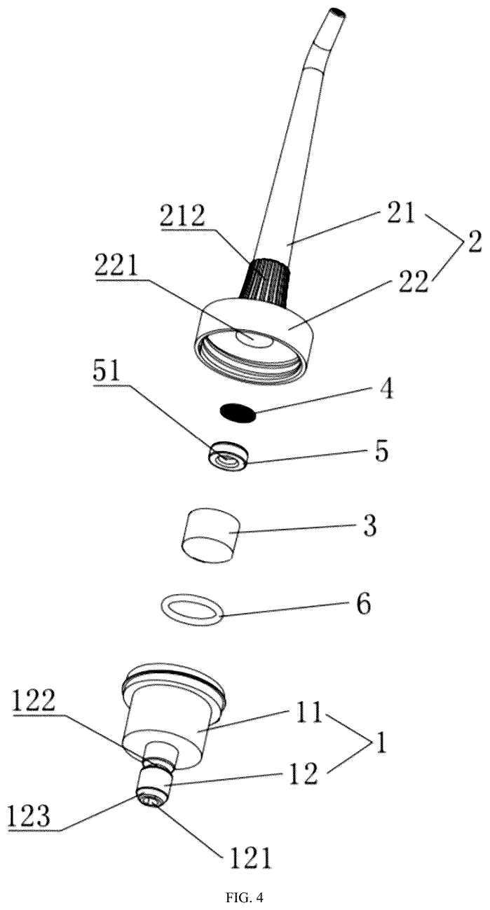

As shown in FIG. 3 and FIG. 4, a sealing ring 6 is provided between the base 1 and the nozzle 2, and a sealing groove 112 for the sealing ring 6 to be inserted and installed is provided in the base 1. It should be noted that the sealing groove 112 cooperates with the sealing ring 6 to seal the nozzle structure. The sealing ring 6 is in an O shape, and the sealing groove 112 is in an annular shape.

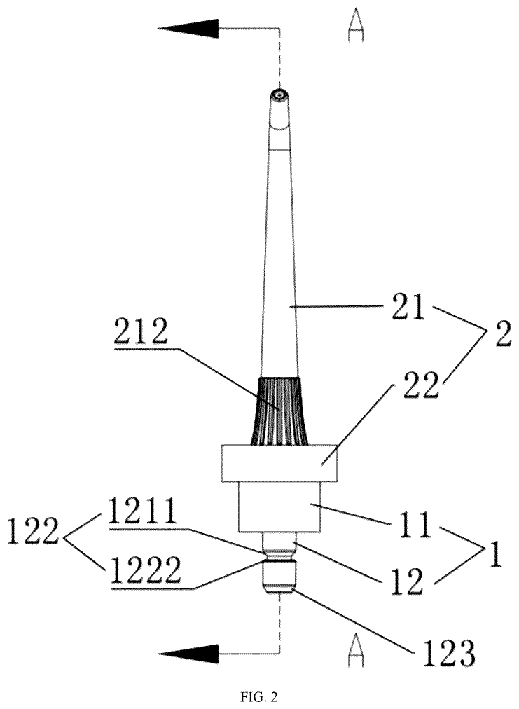

As shown in FIG. 2 to FIG. 4, the base 1 includes a first installation portion 11 and a second installation portion 12. The first installation portion 11 is detachably connected to the nozzle 2, and the second installation portion 12 is installed in the oral irrigator. During the specific implementation process, the first installation portion 11 is integral with the second installation portion 12, and the water inlet channel 121 is provided in the second installation portion 12. One end of the second installation portion 12 is provided with an abutment surface 123 which is convenient for installation of the base 1.

As shown in FIG. 8 and FIG. 9, the base 1 is provided with a positioning post 113, and the nozzle 2 is provided with a positioning hole 222 which the positioning post 113 is snapped on and matches with.

As shown in FIG. 2 to FIG. 4, the second installation portion 12 is provided with a clamping slot 122 for clamping the installation base 1, and the clamping slot 122 is in an annular shape.

As shown in FIG. 2, the first clamping surface 1221 and the second clamping surface 1222 are provided in the clamping groove 122. The first clamping surface 1221 is in an inclined plane, and the second clamping surface 1222 is in a horizontal plane. It should be noted that the first clamping surface 1221 and the second clamping surface 1222 play a snap-in role to facilitate snap-fitting with the button of the oral irrigator, thereby realizing the installation and fixation of the nozzle 2.

As shown in FIG. 3, the nozzle 2 is provided with an installation groove 221 that communicates with the water outlet channel 211. The filter screen 4 is embedded in the installation groove 221. The installation groove 221 is provided with a fastening block 5 for tightening the filter screen 4. During the specific implementation process, the fastening block 5 is inserted in the installation groove 221, and the filter screen 4 is provided with a plurality of circular filter holes 41.

It should be noted that the fastening block 5 is used to tighten the filter screen 4, so that the filter screen 4 is fixedly installed at the nozzle 2 to facilitate filtering of the whitening liquid. The filter screen 4 and the nozzle 2 can be fixed by sleeve connection or ultrasonic welding.

As shown in FIG. 3 and FIG. 4, the fastening block 5 is provided with a through hole 51 communicated with the installation groove 221. During the specific implementation process, the through hole 51 is the circular hole.

As shown in FIG. 2 to FIG. 11, the nozzle 2 includes a nozzle body 21 and a nozzle connection portion 22. The nozzle connection portion 22 is threadedly connected to the base 1. During the specific implementation process, the nozzle connection portion 22 and the nozzle body 21 are an integrally formed structure. The nozzle connection portion 22 is threadedly connected to the first installation portion 11. The water outlet channel 211 is provided in the nozzle body 21, and the installation groove 221 is provided in the nozzle connection portion 22. An anti-slip groove 212 is provided outside of the nozzle body 21, which is convenient for the rotation of the nozzle.

It should also be noted that the nozzle 2 can be snapped on the base 1, or can be adhered to the base 1.

As shown in FIG. 3 to FIG. 11, the whitening agent 3 is a solid tablet or paste.

It should be noted that the water pump of the oral irrigator pumps out water, and water will enter the receiving groove 111 through the water inlet channel 121 of the second installation portion 12 to impact the whitening agent 3, causing the whitening agent 3 to disperse in the water to form the whitening liquid. Due to the filtering of the filter screen 4, the large particles of whitening agent 3 can be prevented from entering the water outlet channel 211, and the whitening liquid is sprayed from the water outlet channel 211 of the nozzle 2 to rinse the user's teeth and achieve teeth whitening.

An embodiment of the present application discloses an oral irrigator, which includes an oral irrigator body and the above-mentioned nozzle structure. The nozzle structure is detachably installed at the oral irrigator body, and the nozzle structure is used to spray whitening liquid. It should be noted that the nozzle structure is installed at the oral irrigator, and the oral irrigator provides water through a water pump to impact the whitening agent 3 in the nozzle structure, thereby forming the whitening liquid for teeth whitening. Then the whitening liquid is sprayed out from the nozzle structure to achieve tooth rinsing and whitening, so that the nozzle structure has a whitening function.

As for the working principle, water enters the receiving groove 111 through the water inlet channel 121, then impacts the whitening agent 3 to form a whitening liquid. The filter screen 4 filters the whitening liquid, and then sprays out from the water outlet channel 211 of the nozzle 2 to rinse the user's teeth and achieve tooth whitening. Therefore, the present application provides a nozzle structure and an oral irrigator thereof, the nozzle has a whitening function, the structure is simple, and the product manufacturing cost can be effectively reduced.

Obviously, the above-mentioned embodiments are only examples for clear explanation and are not intended to limit the scope of the present application. For those skilled in the art, other different forms of changes or modifications can be made based on the above description. An exhaustive list of all implementations is neither necessary nor possible. The obvious changes or modifications derived therefrom shall still fall within the scope of the present application.

What is claimed is:

1. A nozzle structure, comprising:
a base; and
a nozzle connected to the base;
wherein the base is provided with a receiving groove, and a whitening agent is provided inside the receiving groove;
the base is provided with a water inlet channel communicated with the receiving groove; and
the nozzle is provided with a water outlet channel configured to facilitate outflow of whitening liquid, and a filter screen for filtering the whitening liquid is installed at one side of the water outlet channel.

2. The nozzle structure according to claim 1, wherein the nozzle is threadedly connected to the base.

3. The nozzle structure according to claim 1, wherein the nozzle is fixedly connected to the base through screws.

4. The nozzle structure according to claim 1, wherein the nozzle is snapped on and fastened to the base.

5. The nozzle structure according to claim 4, wherein the base is provided with a positioning post, and the nozzle is provided with a positioning hole configured to be snapped on and match with the positioning post.

6. The nozzle structure according to claim 1, wherein the nozzle is provided with an installation groove communicated with the water outlet channel, the filter screen is embedded in the installation groove, and the installation groove is provided with a fastening block for abutting against the filter screen.

7. The nozzle structure according to claim 6, wherein the fastening block is provided with a through hole communicated with the installation groove.

8. The nozzle structure according to claim 1, wherein a sealing ring is provided between the base and the nozzle.

9. The nozzle structure according to claim 1, wherein the whitening agent is a solid tablet or paste.

10. An oral irrigator, comprising an oral irrigator body and the nozzle structure according to claim 1, wherein the nozzle structure is detachably installed at the oral irrigator body, and the nozzle structure is configured to spray the whitening liquid.
